(19) United States
(12) Patent Application Publication
(10) Pub. No.: US 2023/0035678 A1
(43) Pub. Date: Feb. 2, 2023

(54) METHOD AND SYSTEM FOR PROTECTING SECURITY OF HTML5 FILE

(71) Applicant: PAX COMPUTER TECHNOLOGY (SHENZHEN) CO., LTD., Shenzhen, Guangdong (CN)

(72) Inventors: Zhenhua SONG, Shenzhen, Guangdong (CN); Renchi ZHENG, Shenzhen, Guangdong (CN); Jiale REN, Shenzhen, Guangdong (CN)

(21) Appl. No.: 17/791,119

(22) PCT Filed: Mar. 25, 2019
(86) PCT No.: PCT/CN2019/079532

§ 371 Date: Jul. 6, 2022

(30) Foreign Application Priority Data
May 30, 2018 (CN) 201810541506.1

(51) Int. Cl. G06F 21/53; G06F 21/60; G06F 21/57; G06F 21/64

(52) U.S. Cl. CPC G06F 21/53; G06F 21/604; G06F 21/572; G06F 21/64; G06F 2221/2141; G06F 2221/033

(57) ABSTRACT

The present application relates to the technical field of HTML5, and provides a method and a system for protecting security of a HTML5 file, and a terminal device. The embodiment of the present application monitors the operations on the HTML5 resource read-only protection zone by pre-establishing the HTML5 resource read-only protection zone, only allows the system authority process to perform read and write operations on the HTML5 resource read-only protection zone, and writes the data of the local HTML5 resource package into the HTML5 resource read-only protection zone to install HTML5 applications, restricting the HTML5 applications from accessing data in the non-HTML5 resource read-only protection zone, such that the non-system authority processes, including HTML5 applications, to only read the HTML5 resource read-only protection zone, and the system authority process is protected by firmware.

### TECHNICAL FIELD

The present application relates to the technical field of HTML5, and more particularly to a method and a system for protecting security of a HTML5 file, and a terminal device.

### BACKGROUND

HTML is widely used because of its good Web page performance and the ability to access local offline databases, and the applications developed based on HTML5 technology are also growing and popular.

However, with the continuous popularization and application of HTML5 technology, it has become an urgent problem to effectively protect the security of HTML files, prevent HTML files from being tampered with, and reduce the security risks caused by HTML files being tampered with.

### Technical Problem

In view of this, embodiments of the present application provide a method and a system for protecting security of a HTML5 file, and a terminal device, which can effectively protect the security of HTML files, prevent HTML files from being tampered with, and reduce security risks caused by HTML files being tampered with.

### SUMMARY

A first aspect of an embodiment of the present application provides a method for protecting security of a HTML5 file, which includes:

monitoring an operation on a preset HTML5 resource read-only protection zone through a system authority service;

allowing to execute a write operation when the operation is the write operation executed by a system authority process; wherein the write operation is configured for writing data of a local HTML5 resource package into the HTML5 resource read-only protection zone to install a HTML5 application;

monitoring data accessed by a built-in browser kernel of the HTML5 application when the HTML5 application is installed;

restricting an access operation of the built-in browser kernel when the data accessed by the built-in browser kernel is data of a non-HTML5 resource read-only protection zone;

allowing to execute a read operation when the operation is the read operation executed by a non-system authority process; wherein non-system authority process comprises the HTML5 application;

and restricting to execute a non-read operation when the operation is the non-read operation executed by the non-system authority process.

A second aspect of an embodiment of the present application provides a system for protecting safety of an HTML5 application, which includes:

a first monitoring module, configured for monitoring an operation on a preset HTML5 resource read-only protection zone through a system authority service;

a first authority control module, configured for allowing to execute a write operation when the operation is the write operation executed by a system authority process; wherein the write operation is configured for writing data of a local HTML5 resource package into the HTML5 resource read-only protection zone to install a HTML5 application;

a second monitoring module, configured for monitoring data accessed by a built-in browser kernel of the HTML5 application when the HTML5 application is installed;

a second authority control module, configured for restricting an access operation of the built-in browser kernel when the data accessed by the built-in browser kernel is data of a non-HTML5 resource read-only protection zone;

a third authority control module, configured for allowing to execute a read operation when the operation is the read operation executed by a non-system authority process; wherein non-system authority process comprises the HTML5 application; and

a fourth authority control module, configured for restricting to execute a non-read operation when the operation is the non-read operation executed by the non-system authority process.

A third aspect of an embodiment of the present application provides a terminal device, which includes a memory, a processor and a computer program stored in the memory and running on the processor, wherein the processor executes the computer program to implement steps of the method above-mentioned.

A fourth aspect of an embodiment of the present application provides a computer-readable storage medium, the computer-readable storage medium stores a computer program, when the computer program is executed by a processor, steps of the method above-mentioned are implemented.

### BENEFIT EFFECT

The embodiment of the present application monitors the operations on the HTML5 resource read-only protection zone by pre-establishing the HTML5 resource read-only protection zone, only allows the system authority process to perform read and write operations on the HTML5 resource read-only protection zone, and writes the data of the local HTML5 resource package into the HTML5 resource read-only protection zone to install HTML5 applications, restricting the HTML5 applications from accessing data in the non-HTML5 resource read-only protection zone, such that the non-system authority processes, including HTML5 applications, to only read the HTML5 resource read-only protection zone, and the system authority process is protected by firmware, which can effectively protect the security of the HTML file, prevent the HTML file from being tampered with, and reduce the security risks caused by the HTML file being tampered with.

### BRIEF DESCRIPTION OF THE DRAWINGS

In order to explain the technical solutions in the embodiments of the present application more clearly, the following briefly introduces the accompanying drawings that need to be used in the description of the embodiments or the prior art. Obviously, the drawings in the following description are only for the present application. In some embodiments, for those of ordinary skill in the art, other drawings can also be obtained according to these drawings without any creative effort.

FIG. 1 is a schematic flowchart of a method for protecting security of a HTML5 file provided in Embodiment 1 of the present application;

FIG. 2 is a schematic flowchart of a method for protecting security of a HTML5 file provided in Embodiment 2 of the present application;

FIG. 3 is a schematic structural diagram of a system for protecting security of a HTML5 file provided by Embodiment 3 of the present application; and

FIG. 4 is a schematic diagram of a terminal device according to Embodiment 4 of the present application.

### DETAILED DESCRIPTION

In the following description, for the purpose of illustration rather than limitation, specific details such as specific system structures and technologies are set forth in order to provide a thorough understanding of the embodiments of the present application. However, it will be apparent to those skilled in the art that the present application may be practiced in other embodiments without these specific details. In other instances, detailed descriptions of well-known systems, devices, circuits, and methods are omitted so as not to obscure the description of the present application with unnecessary detail.

In order to illustrate the technical solutions of the present application, the following specific embodiments are used for description.

### Embodiment 1

The embodiment provides a method for protecting security of a HTML5 file, which is applied to any terminal device that can run an operating system (OS), such as a mobile phone, a tablet computer, a smart bracelet, a personal digital assistant, and a point of sale (POS), server, Personal Computer (PC) client terminal, etc. The operating system can be used to control and manage applications based on HTML technology, ie HTML applications.

In one embodiment, the terminal device is a POS, and the operating system is an Android operating system.

In the embodiment, the HTML5 file includes the related configuration file of the installation package of the HTML5 application itself, the HTML5 resource package, and the HTML5 application.

In a specific application, when the operating system is an Android operating system, the HTML5 application is an Android HTML5 application, the installation package is an Android Package (APK), and the resource package is an Android HTML5 resource package.

In a specific application, the method for protecting security of a HTML5 file is performed by a firmware.

The method for protecting security of a HTML5 file provided in the embodiment is suitable for the situation where only the local HTML5 resource package can be called, and the non-local HTML5 resource package cannot be called through the operation of other browsers connected to the Internet, and is used to ensure that the built-in browser of the firmware accesses data Security of the source.

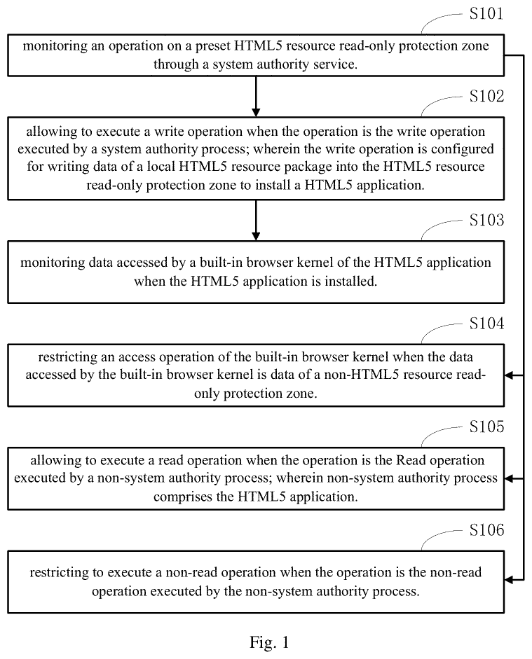

As shown in FIG. 1, the method for protecting security of a HTML5 file provided by the embodiment includes:

Step S101: monitoring an operation on a preset HTML5 resource read-only protection zone through a system authority service.

In one embodiment, before step S101, the method includes:

presetting a HTML5 resource read-only protection zone.

In specific applications, it is not allowed to specify the storage space of the storage medium outside the terminal device (for example, Secure Digital Memory Card (SD)) as the HTML5 resource read-only protection zone, and the storage space of the internal storage medium should be designated as the HTML5 resource read-only protection zone, when the address of the specified HTML5 resource read-only protection zone is in a location that cannot directly limit the access rights of the file system (for example, the storage space of the internal SD card), the non-read operations of the file at the address should be restricted by the system firewall. The non-read operation specifically refers to an operation other than a read operation, such as a write operation, a modification operation, a delete operation, a creation operation, an editing operation, etc., which cause the data in the read-only protection zone of the HTML5 resource to be tampered with.

Step S102: allowing to execute a write operation when the operation is the write operation executed by a system authority process; wherein the write operation is configured for writing data of a local HTML5 resource package into the HTML5 resource read-only protection zone to install a HTML5 application.

In specific applications, only system authority processes are allowed to write to the read-only protection zone of HTML5 resources.

In one embodiment, before step S102, the method includes:

verifying the local HTML5 resource package;

when the verification of the local HTML5 resource package is passed, entering the step S102.

In a specific application, before writing the local HTML5 resource package into the HTML5 resource read-only protection zone, the authenticity and integrity of the local HTML5 resource package need to be verified.

In one embodiment, after step S102, the method includes:

verifying the local HTML5 resource package written into the read-only protection zone of the HTML5 resource every preset time period;

When the verification of the local HTML5 resource package fails, the operating system is notified to trigger the protection of the read-only protection zone of the HTML5 resource.

In specific applications, only system authority processes are allowed to write to the HTML5 resource read-only protection zone. Although it can protect against attacks on the HTML5 resource read-only protection zone by other applications of non-system authority processes, however, this method cannot protect system services and the 0-day (cracked version) vulnerabilities of the built-in browser kernel, once the attacker gains the service authority of the operating system or the authority of the built-in browser kernel, the HTML5 resource read-only protection zone will not be protected, and the operating system will not be able to know the specific content that has been tampered with by the attacker. Therefore, it is necessary to periodically self-check the authenticity and integrity of the HTML5 resource read-only protection zone itself.

In one embodiment, before the step S102, the method includes:

verifying the installation package of the HTML5 application;

verifying the local HTML5 resource package when downloading the local HTML5 resource package; and

when both the verification of the installation package of the HTML5 application and the local HTML5 resource package are passed, entering the step S102.

In a specific application, when downloading the local HTML5 resource package, the authenticity and integrity of the local HTML5 resource package need to be verified, and before installing the HTML5 application, the installation package of the HTML5 application itself needs to be verified.

Step S103: monitoring data accessed by a built-in browser kernel of the HTML5 application when the HTML5 application is installed.

In a specific application, the HTML5 application in the HTML5 security architecture corresponding to the non-built-in browser that comes with the operating system only includes the shell of the browser and does not include the browser kernel; the HTML5 corresponding to the built-in browser of the firmware in the embodiment HTML5 applications in a secure architecture contain a built-in browser kernel.

In a specific application, only the data in the HTML5 resource read-only protection zone that has passed the authentication is allowed to be accessed and used by the built-in browser kernel. Since the built-in browser kernel can support very strong scalability, it is necessary to impose strict data entry restrictions on the sources of data supported by the built-in browser kernel to ensure that the built-in browser kernel cannot access data outside the HTML5 resource read-only protection zone by accessing illegal addresses.

Step S104: restricting an access operation of the built-in browser kernel when the data accessed by the built-in browser kernel is data of a non-HTML5 resource read-only protection zone.

In one embodiment, the data of the non-HTML5 resource read-only protection zone includes:

data with access paths being different from that of the data in the HTML5 resource read-only protection zone; and

data with access paths existing outside the HTML5 resource read-only protection zone and comprising relative paths of the data in the HTML5 resource read-only protection zone.

In specific applications, it is necessary to restrict the browser kernel to directly access addresses including protocols such as http, ftp, scp, and file, and only allow access to relative paths of data in the HTML5 resource read-only protection zone. However, since the file path of the data in the HTML5 resource package cannot be linked to the specific location of the data in the HTML5 resource read-only protection zone, even if the relative paths of the data in the HTML5 resource read-only protection zone are allowed to be accessed, out-of-bounds protection should be set. For example, the address of the file of the HTML5 resource package in the file system is as follows:

/Share/bankpay/resource.htm

/Share/banklife/resource.htm

If the resource.htm in the HTML5 resource package of banklife contains a hyperlink with src=“../bankpay/resource.htm”, then the HTML5 resource package banklife can access the resources of other resource packages through the out-of-bounds “..”. In this case, it should be checked by the operating system that it is an illegal relative path and access is prohibited, otherwise all files in the file system can be accessed through the out-of-bounds address segment.

In one embodiment, restricting the access operation of the built-in browser kernel includes:

restricting the access operation of the built-in browser kernel by means of URI interception, URL interception or file handle interception.

Step S105: allowing to execute a read operation when the operation is the read operation executed by a non-system authority process; wherein non-system authority process comprises the HTML5 application; and

Step S106: restricting to execute a non-read operation when the operation is the non-read operation executed by the non-system authority process.

In specific applications, only other applications other than the system installation are allowed to read the data in the HTML5 resource read-only protection zone, and the non-read operations of these other applications are restricted to prevent the data in the read-only protection zone of HTML5 resources from being tampered.

### Embodiment 2

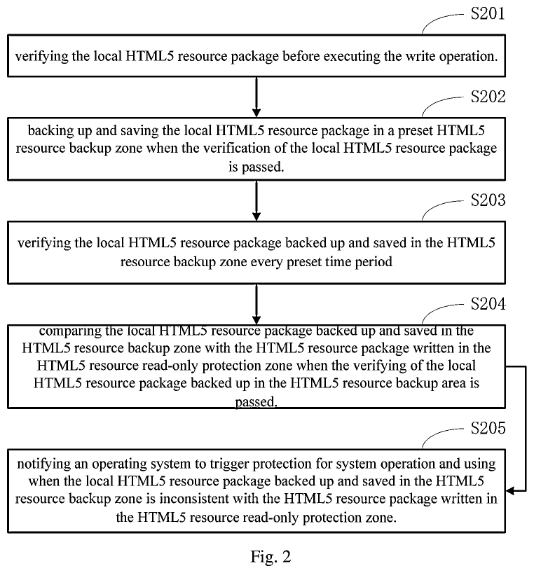

As shown in FIG. 2, in the embodiment, the method for protecting security of a HTML5 file in Embodiment 1 further includes:

Step S201: verifying the local HTML5 resource package before executing the write operation.

In a specific application, before writing the local HTML5 resource package into the HTML5 resource read-only protection zone, the authenticity and integrity of the local HTML5 resource package need to be verified.

Step S202: backing up and saving the local HTML5 resource package in a preset HTML5 resource backup zone when the verification of the local HTML5 resource package is passed.

In a specific application, when the verification of the local HTML5 resource package is passed, the local HTML5 resource package needs to be backed up and saved. The Step S202 may be performed before step S102, when step S102 is performed, or after step S102 is performed.

In one embodiment, before step S202, the method includes:

presetting a HTML5 resource backup zone.

It should be understood that the addresses of the HTML5 resource backup zone and the HTML5 resource read-only protection zone are different, belong to different data storage zones, and have storage spaces that are completely non-intersecting and non-overlapping.

In the embodiment, after step S202, the method includes:

Step S203: verifying the local HTML5 resource package backed up and saved in the HTML5 resource backup zone every preset time period;

Step S204: comparing the local HTML5 resource package backed up and saved in the HTML5 resource backup zone with the HTML5 resource package written in the HTML5 resource read-only protection zone when the verifying of the local HTML5 resource package backed up in the HTML5 resource backup area is passed; and

Step S205: notifying an operating system to trigger protection for system operation and using when the local HTML5 resource package backed up and saved in the HTML5 resource backup zone is inconsistent with the HTML5 resource package written in the HTML5 resource read-only protection zone.

In the embodiment, the protection of system operation and using refers to the protection of various operations and using conditions of the operating system itself.

In a specific application, the authenticity and integrity of the HTML5 resource read-only protected area itself can be checked by periodically comparing whether the local HTML5 resource package saved in the HTML5 resource backup zone is inconsistent with the HTML5 resource package written in the HTML5 resource read-only protection zone.

In one embodiment, the verification includes authenticity verification and integrity verification.

In specific applications, the verification should include both authenticity verification and integrity verification.

It should be understood that the size of the sequence numbers of the steps in the above embodiments does not mean the sequence of execution, and the execution sequence of each process should be determined by its function and internal logic, and should not constitute any limitation to the implementation process of the embodiments of the present application.

### Embodiment 3

The embodiment provides a system for protecting security of a HTML5 file, which is used to execute the method steps in the first or second embodiment. The system for protecting security of a HTML5 file can be a software program system in any terminal device that can run an operating system (OS).

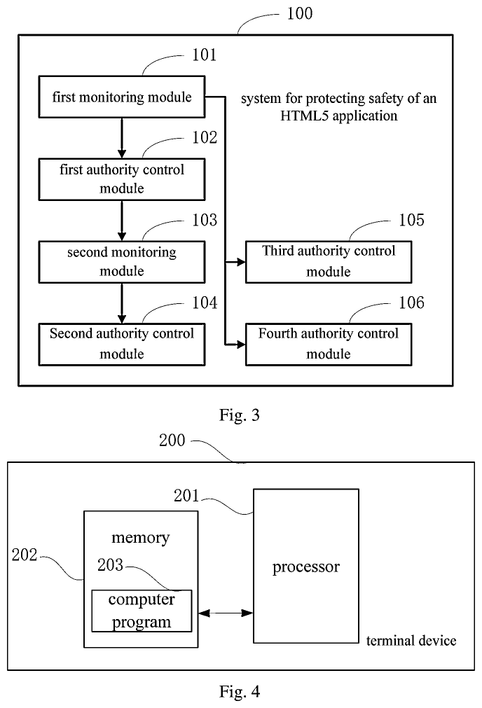

As shown in FIG. 3, the system for protecting security of a HTML5 file provided by this embodiment includes:

a first monitoring module 101, configured for monitoring an operation on a preset HTML5 resource read-only protection zone through a system authority service;

a first authority control module 102, configured for allowing to execute a write operation when the operation is the write operation executed by a system authority process; wherein the write operation is configured for writing data of a local HTML5 resource package into the HTML5 resource read-only protection zone to install a HTML5 application;

a second monitoring module 103, configured for monitoring data accessed by a built-in browser kernel of the HTML5 application when the HTML5 application is installed;

a second authority control module 104, configured for restricting an access operation of the built-in browser kernel when the data accessed by the built-in browser kernel is data of a non-HTML5 resource read-only protection zone;

a third authority control module 105, configured for allowing to execute a read operation when the operation is the read operation executed by a non-system authority process; wherein non-system authority process comprises the HTML5 application; and

a fourth authority control module 106, configured for restricting to execute a non-read operation when the operation is the non-read operation executed by the non-system authority process.

In one embodiment, the system for protecting security of a HTML5 file further includes: a read-only protection zone setting module, configured for presetting the HTML5 resource read-only protection zone.

In one embodiment, the system for protecting security of a HTML5 file further includes:

a verification module, configured for verifying the local HTML5 resource package; and

a skipping module, configured for skipping to the first authority control module when the local HTML5 resource package is verified.

In one embodiment, the system for protecting security of a HTML5 file further includes:

the second verification module is further configured for verifying the local HTML5 resource package written into the HTML5 resource read-only protection zone every preset time period;

The system for protecting security of a HTML5 file further includes a notification module, configured for notifying the operating system to trigger protection for system operation and using when the local HTML5 resource package fails to pass the verification.

In one embodiment, the verification module is further configured for:

verifying an installation package of the HTML5 application;

verifying a local HTML5 resource package when downloading the local HTML5 resource package; and

the skipping module is further configured for skipping to the first authority control module when both the verification of the installation package of the HTML5 application and the local HTML5 resource package are passed.

In one embodiment, the verification module is further configured for verifying the local HTML5 resource package before executing the write operation.

The system for protecting security of a HTML5 file further includes a storage module, configured for backing up and saving the local HTML5 resource package in a preset HTML5 resource backup zone when the local HTML5 resource package is verified.

In one embodiment, the system for protecting security of a HTML5 file further includes:

a backup zone setting module, configured for presetting the HTML5 resource backup zone.

In one embodiment, the verification module is further configured for verifying the local HTML5 resource package backed up and saved in the HTML5 resource backup zone every preset time period;

The system for protecting security of a HTML5 file further includes:

a comparison module, configured for comparing the local HTML5 resource package backed up and saved in the HTML5 resource backup zone with the HTML5 resource package written in the HTML5 resource read-only protection zone when the verifying of the local HTML5 resource package backed up in the HTML5 resource backup area is passed; and

the notification module is further configured for notifying an operating system to trigger protection for system operation and using when the local HTML5 resource package backed up and saved in the HTML5 resource backup zone is inconsistent with the HTML5 resource package written in the HTML5 resource read-only protection zone.

### Embodiment 4

As shown in FIG. 4, an embodiment of the present application provides a terminal device 200, which includes: a processor 201, a memory 202, and a computer program 203 stored in the memory 202 and executable on the processor 201, for example, the program of a method for protecting security of a HTML5 file. When the processor 201 executes the computer program 203, the steps in each of the foregoing embodiments of the method for protecting security of a HTML5 file are implemented, for example, steps S101 to S106 shown in FIG. 1. Alternatively, when the processor 201 executes the computer program 203, the functions of the modules in the foregoing device embodiments are implemented, for example, the functions of the modules 101 to 106 shown in FIG. 3.

Exemplarily, the computer program 203 may be divided into one or more modules, and the one or more modules are stored in the memory 202 and executed by the processor 201 to complete the present application. The one or more modules may be a series of computer program instruction segments capable of performing specific functions, and the instruction segments are used to describe the execution process of the computer program 203 in the terminal device 200. For example, the computer program 203 can be divided into a first monitoring module, a first authority control module, a second monitoring module, a second authority control module, a third authority control module, and a fourth authority control module. The specific functions of each module are as follows:

the first monitoring module, configured for monitoring an operation on a preset HTML5 resource read-only protection zone through a system authority service;

the first authority control module, configured for allowing to execute a write operation when the operation is the write operation executed by a system authority process; wherein the write operation is configured for writing data of a local HTML5 resource package into the HTML5 resource read-only protection zone to install a HTML5 application;

the second monitoring module, configured for monitoring data accessed by a built-in browser kernel of the HTML5 application when the HTML5 application is installed;

the second authority control module, configured for restricting an access operation of the built-in browser kernel when the data accessed by the built-in browser kernel is data of a non-HTML5 resource read-only protection zone;

the third authority control module, configured for allowing to execute a read operation when the operation is the read operation executed by a non-system authority process; wherein non-system authority process comprises the HTML5 application; and

the fourth authority control module, configured for restricting to execute a non-read operation when the operation is the non-read operation executed by the non-system authority process.

The terminal device 200 may be a computing device such as a desktop computer, a notebook computer, a palmtop computer, and a cloud server. The terminal device may include, but is not limited to, the processor 201 and the memory 202. Those skilled in the art can understand that FIG. 4 is only an example of the terminal device 200, and does not constitute a limitation on the terminal device 200, and may include more or less components than the one shown, or combine some components, or different components, for example, the terminal device may further include an input and output device, a network access device, a bus, and the like.

The so called processor 201 can be CPU (Central Processing Unit), and can also be other general purpose processor, DSP (Digital Signal Processor), ASIC (Application Specific Integrated Circuit), FGPA (Field-Programmable Gate Array), or some other programmable logic devices, discrete gate or transistor logic device, discrete hardware component, etc. The general purpose processor can be a microprocessor, or alternatively, the processor can also be any conventional processor and so on.

The memory 202 can be an internal storage unit of the terminal device 200, such as a hard disk or a memory of the terminal device 200. The memory 202 can also be an external storage device of the terminal device 200, such as a plug-in hard disk, a SMC (Smart Media Card), a SD (Secure Digital) card, a FC (Flash Card) equipped on the terminal device 200. Further, the memory 202 may include both the internal storage unit and the external storage device of the terminal device 200, either. The memory 202 is configured to store the computer programs, and other procedures and data needed by the terminal device 200 for determining wellbore cross-sectional shape. The memory 202 can also be configured to storing data that has been output or being ready to be output temporarily.

It can be clearly understood by the those skilled in the art that, for describing conveniently and concisely, dividing of the aforesaid various functional units, functional modules is described exemplarily merely, in an actual application, the aforesaid functions can be assigned to different functional units and functional modules to be accomplished, that is, an inner structure of a data synchronizing device is divided into functional units or modules so as to accomplish the whole or a part of functionalities described above. The various functional units, modules in the embodiments can be integrated into a processing unit, or each of the units exists independently and physically, or two or more than two of the units are integrated into a single unit. The aforesaid integrated unit can by either actualized in the form of hardware or in the form of software functional units. In addition, specific names of the various functional units and modules are only used for distinguishing from each other conveniently, but not intended to limit the protection scope of the present application. Regarding a specific working process of the units and modules in the aforesaid device, reference can be made to a corresponding process in the aforesaid method embodiments, it is not repeatedly described herein.

In the aforesaid embodiments, the description of each of the embodiments is emphasized respectively, regarding a part of one embodiment which isn't described or disclosed in detail, please refer to relevant descriptions in some other embodiments.

Those skilled in the art may aware that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

It should be understood that, in the embodiments of the present application, the disclosed device/terminal device and method could be implemented in other ways. For example, the device described above are merely illustrative; for example, the division of the units is only a logical function division, and other division could be used in the actual implementation, for example, multiple units or components could be combined or integrated into another system, or some features can be ignored, or not performed. In another aspect, the coupling or direct coupling or communicating connection shown or discussed could be an indirect, or a communicating connection through some interfaces, devices or units, which could be electrical, mechanical, or otherwise.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

In addition, the various functional units in each of the embodiments of the present application can be integrated into a single processing unit, or exist individually and physically, or two or more than two units are integrated into a single unit. The aforesaid integrated unit can either be achieved by hardware, or be achieved in the form of software functional units.

If the integrated unit is achieved in the form of software functional units, and is sold or used as an independent product, it can be stored in a computer readable storage medium. Based on this understanding, a whole or part of flow process of implementing the method in the aforesaid embodiments of the present application can also be accomplished by using computer program to instruct relevant hardware. When the computer program is executed by the processor, the steps in the various method embodiments described above can be implemented. Wherein, the computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory), electrical carrier signal, telecommunication signal and software distribution medium, etc. It needs to be explained that, the contents contained in the computer readable medium can be added or reduced appropriately according to the requirement of legislation and patent practice in a judicial district, for example, in some judicial districts, according to legislation and patent practice, the computer readable medium doesn't include electrical carrier signal and telecommunication signal.

As stated above, the aforesaid embodiments are only intended to explain but not to limit the technical solutions of the present application. Although the present application has been explained in detail with reference to the above-described embodiments, it should be understood for the ordinary skilled one in the art that, the technical solutions described in each of the above-described embodiments can still be amended, or some technical features in the technical solutions can be replaced equivalently; these amendments or equivalent replacements, which won't make the essence of corresponding technical solution to be broken away from the spirit and the scope of the technical solution in various embodiments of the present application, should all be included in the protection scope of the present application.

1. A method for protecting security of a HTML5 file, comprising:
monitoring an operation on a preset HTML5 resource read-only protection zone through a system authority service;
allowing to execute a write operation when the operation is the write operation executed by a system authority process; wherein the write operation is configured for writing data of a local HTML5 resource package into the HTML5 resource read-only protection zone to install a HTML5 application;
monitoring data accessed by a built-in browser kernel of the HTML5 application when the HTML5 application is installed;
restricting an access operation of the built-in browser kernel when the data accessed by the built-in browser kernel is data of a non-HTML5 resource read-only protection zone;
allowing to execute a read operation when the operation is the read operation executed by a non-system authority process; wherein non-system authority process comprises the HTML5 application; and
restricting to execute a non-read operation when the operation is the non-read operation executed by the non-system authority process.

2. The method for protecting security of a HTML5 file according to claim 1, wherein the method further comprises:
verifying the local HTML5 resource package before executing the write operation; and
backing up and saving the local HTML5 resource package in a preset HTML5 resource backup zone when the verification of the local HTML5 resource package is passed.

3. The method for protecting security of a HTML5 file according to claim 2, wherein after backing up and saving the local HTML5 resource package in a preset HTML5 resource backup zone when the verification of the local HTML5 resource package is passed, the method further comprises:
verifying the local HTML5 resource package backed up and saved in the HTML5 resource backup zone every preset time period;
comparing the local HTML5 resource package backed up and saved in the HTML5 resource backup zone with the HTML5 resource package written in the HTML5 resource read-only protection zone when the verifying of the local HTML5 resource package backed up in the HTML5 resource backup area is passed; and
notifying an operating system to trigger protection for system operation and using when the local HTML5 resource package backed up and saved in the HTML5 resource backup zone is inconsistent with the HTML5 resource package written in the HTML5 resource read-only protection zone.

4. The method for protecting security of a HTML5 file according to claim 1, wherein before allowing to execute a write operation when the operation is the write operation executed by a system authority process, the method comprises:
verifying an installation package of the HTML5 application;
verifying a local HTML5 resource package when downloading the local HTML5 resource package; and
allowing to execute the write operation when both the verification of the installation package of the HTML5 application and the local HTML5 resource package are passed.

5. The method for protecting security of a HTML5 file according to claim 2, wherein the verification comprises authenticity verification and integrity verification.

6. The method for protecting security of a HTML5 file according to claim 1, wherein the data of the non-HTML5 resource read-only protection zone comprises:
data with access paths being different from that of the data in the HTML5 resource read-only protection zone; and
data with access paths existing outside the HTML5 resource read-only protection zone and comprising relative paths of the data in the HTML5 resource read-only protection zone.

7. The method for protecting security of a HTML5 file according to claim 1, wherein restricting an access operation of the built-in browser kernel comprises:
restricting the access operation of the built-in browser kernel by means of URI interception, URL interception or file handle interception.

8. (canceled)

9. A terminal device comprising a memory, a processor and a computer program stored in the memory and running on the processor, wherein the processor executes the computer program to implement steps of a method for protecting security of a HTML5 file, and the processor is configured for executing:
monitoring an operation on a preset HTML5 resource read-only protection zone through a system authority service;
allowing to execute a write operation when the operation is the write operation executed by a system authority process; wherein the write operation is configured for writing data of a local HTML5 resource package into the HTML5 resource read-only protection zone to install a HTML5 application;
monitoring data accessed by a built-in browser kernel of the HTML5 application when the HTML5 application is installed;
restricting an access operation of the built-in browser kernel when the data accessed by the built-in browser kernel is data of a non-HTML5 resource read-only protection zone;
allowing to execute a read operation when the operation is the read operation executed by a non-system authority process; wherein non-system authority process comprises the HTML5 application; and
restricting to execute a non-read operation when the operation is the non-read operation executed by the non-system authority process.

10. A computer-readable storage medium, wherein the computer-readable storage medium stores a computer program, when the computer program is executed by a processor, steps of a method for protecting security of a HTML5 file are implemented, and the processor is configured for executing:
monitoring an operation on a preset HTML5 resource read-only protection zone through a system authority service;
allowing to execute a write operation when the operation is the write operation executed by a system authority process; wherein the write operation is configured for writing data of a local HTML5 resource package into the HTML5 resource read-only protection zone to install a HTML5 application;
monitoring data accessed by a built-in browser kernel of the HTML5 application when the HTML5 application is installed;
restricting an access operation of the built-in browser kernel when the data accessed by the built-in browser kernel is data of a non-HTML5 resource read-only protection zone;
allowing to execute a read operation when the operation is the read operation executed by a non-system authority process; wherein non-system authority process comprises the HTML5 application; and
restricting to execute a non-read operation when the operation is the non-read operation executed by the non-system authority process.

11. The terminal device according to claim 9, wherein the processor is configured for executing:
verifying the local HTML5 resource package before executing the write operation; and
backing up and saving the local HTML5 resource package in a preset HTML5 resource backup zone when the verification of the local HTML5 resource package is passed.

12. The terminal device according to claim 11, wherein after backing up and saving the local HTML5 resource package in a preset HTML5 resource backup zone when the verification of the local HTML5 resource package is passed, the processor is configured for executing:
verifying the local HTML5 resource package backed up and saved in the HTML5 resource backup zone every preset time period;
comparing the local HTML5 resource package backed up and saved in the HTML5 resource backup zone with the HTML5 resource package written in the HTML5 resource read-only protection zone when the verifying of the local HTML5 resource package backed up in the HTML5 resource backup area is passed; and
notifying an operating system to trigger protection for system operation and using when the local HTML5 resource package backed up and saved in the HTML5 resource backup zone is inconsistent with the HTML5 resource package written in the HTML5 resource read-only protection zone.

13. The terminal device according to claim 9, wherein before allowing to execute a write operation when the operation is the write operation executed by a system authority process, the processor is configured for executing:
verifying an installation package of the HTML5 application;
verifying a local HTML5 resource package when downloading the local HTML5 resource package; and
allowing to execute the write operation when both the verification of the installation package of the HTML5 application and the local HTML5 resource package are passed.

14. The terminal device according to claim 11, wherein the verification comprises authenticity verification and integrity verification.

15. The terminal device according to claim 12, wherein the verification comprises authenticity verification and integrity verification.

16. The terminal device according to claim 13, wherein the verification comprises authenticity verification and integrity verification.

17. The terminal device according to claim 9, wherein the data of the non-HTML5 resource read-only protection zone comprises:
data with access paths being different from that of the data in the HTML5 resource read-only protection zone; and
data with access paths existing outside the HTML5 resource read-only protection zone and comprising relative paths of the data in the HTML5 resource read-only protection zone.

18. The terminal device according to claim 9, wherein restricting an access operation of the built-in browser kernel comprises:
restricting the access operation of the built-in browser kernel by means of URI interception, URL interception or file handle interception.

19. The method for protecting security of a HTML5 file according to claim 3, wherein the verification comprises authenticity verification and integrity verification.

20. The method for protecting security of a HTML5 file according to claim 4, wherein the verification comprises authenticity verification and integrity verification.
